(19) United States
(12) Patent Application Publication
(10) Pub. No.: US 2012/0066262 A1
(43) Pub. Date: Mar. 15, 2012

(54) User-Controlled Management and Distribution of User Information

(76) Inventor: David M. Greenberg, New York, NY (US)

(21) Appl. No.: 12/882,026

(22) Filed: Sep. 14, 2010

(51) Int. Cl. G06F 17/30; G06F 15/16

(52) U.S. Cl. 707/784; 707/E17.12

(57) ABSTRACT

A first portal is configured to receive user information that includes at least one of contact data or biographical data associated with a particular user. The first portal is further configured to receive user selected information that includes at least a subset of the user information associated with the particular user and identifies a particular database operator to receive the subset of user information. A core system includes a server and a database to store the user information and the user selected information. A first data connection is configured to transfer the user information and the user selected information received through the first portal to the core system. A second portal is configured to provide the particular database operator with access to a first data feed. The first data feed includes the subset of user information associated with the particular user and is accessible only by the particular database operator and the second portal is further configured to provide a second different database operator with access to a second data feed. The second data feed is accessible only by the second different database operator.

### TECHNICAL FIELD

This disclosure relates to a user-controlled system for managing and distributing user information.

### BACKGROUND

Typically, an individual's contact information (e.g., name, mailing address, phone number) changes multiple times throughout her life. For example, after a person moves into a new home, her home mailing address changes. Typically, each time the individual's contact information changes, she will provide her updated contact information separately to various database operators, such as credit card companies, banks, utilities, businesses, schools, etc. Because the individual separately contacts each database operator, the individual can fail to provide her updated contact information to all of the database operators with which she has a relationship. For example, after moving to a new apartment, the individual can fail to provide her new mailing address and/or home phone number to her college alumni organization. Further, the process of updating numerous recipients separately is inefficient and time-consuming for individuals.

Database operators have an interest in maintaining accurate records of their membership population. For ease of discussion, the term “member” is meant to refer to individuals with whom the database operator has a relationship, such as customers, clients or alumni. As indicated above, individuals do not necessarily provide their updated information to all of the database operators with which they have a relationship. For many database operators, this causes the accuracy of their records to deteriorate over time (i.e., many database operators experience data decay). As a result of this decay, many database operators cannot reliably contact their members and/or analyze their membership populations.

Database operators that seek to improve the accuracy of their databases can use various “data cleansing” services to find inaccuracies in their database and correct inaccurate information. Some data cleansing methods involve the periodic comparison of the database operator's database to United States Postal change of address files and/or consumer information files owned or provided by database-marketing firms.

### SUMMARY

The details of one or more implementations of the invention are set forth in the accompanying drawings and the description below. Various aspects are set forth in the claims.

In one aspect, a system includes a first portal that is configured to receive user information. The user information includes at least one of contact data or biographical data associated with a particular user. The first portal is further configured to receive user selected information that includes at least a subset of the user information associated with the particular user and identifies a particular database operator to receive the subset of user information. The system also includes a core system, which includes a server and a database to store the user information and the user selected information. The system includes a data connection configured to transfer the user information and the user selected information received through the first portal to the core system. The system includes a second portal configured to provide the particular database operator with access to a first data feed. The first data feed includes the subset of user information associated with the particular user and is accessible only by the particular database operator. The second portal is further configured to provide a second different database operator with access to a second data feed. Each data feed is individualized for the applicable database operator and includes only the user information associated with the users that designated the applicable database operator as a recipient for their user information.

Other features, and aspects, as well as various advantages, will be apparent from the description and drawings, and from the claims.

### BRIEF DESCRIPTION OF DRAWINGS

FIG. 1 is an illustration of an example user information distribution system.

FIGS. 2A-2D are illustrations of example submission portal user interfaces.

FIG. 3 is a flowchart of an example submission portal use scenario.

FIG. 4 is an illustration of an example feed portal interface.

FIG. 5 is an illustration of an example feed portal interface displaying user information.

FIG. 6 is flowchart of an example method to provide users with suggested database operators.

FIG. 7 is an illustration of an example feed portal interface to upload membership lists.

FIG. 8 is an illustration of an example submission portal interface to display suggested database operators.

FIG. 9 is an illustration of an example feed portal interface to send information requests.

FIG. 10 is an illustration of an example information request email.

FIG. 11 is an illustration of an example modified submission portal form.

FIGS. 12A-12B are flowcharts of an example modified submission portal form use scenario.

### DETAILED DESCRIPTION

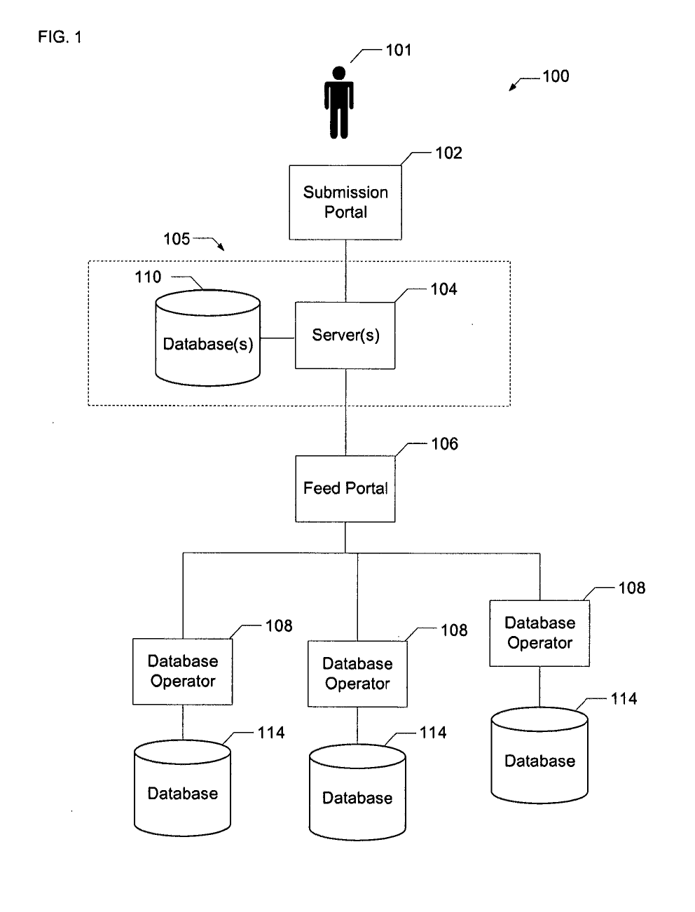

FIG. 1 illustrates an example user information distribution system 100. The system 100 includes a submission portal 102, one or more servers 104, a feed portal 106, and one or more databases 110. The server(s) 104, together with the databases(s) 110, can be referred to as the core system 105.

In general, the user information distribution system 100 allows a user 101 to submit her user information (i.e., any relevant information associated with the user 101 such as contact information, personal information, or behavioral information) through the submission portal 102. The submission portal 102 is connected, through the core system 105, to the feed portal 106, which provides the user information to multiple recipients, such as database operators 108 (e.g., businesses, organizations, schools, individuals or any group that maintains a database of information relating to affiliates or members). The database operators 108 interact with the feed portal 106 and each can access a data feed that comprises user information. As explained below, the data feed is individualized for each database operator 108 and includes only the user information associated with users 101 that designated the database operator 108 as a recipient of their user information.

Various aspects of the system 100 can be implemented in hardware, software or a combination of hardware and software. Circuitry, including dedicated or general purpose machines, such as computer systems and processors, can be adapted to execute machine-readable instructions to implement the techniques described above. Computer-executable instructions for implementing the techniques can be stored, for example, as encoded information on a computer-readable medium such as a magnetic floppy disk, magnetic tape, compact disc read only memory (CD-ROM), or other machine-readable medium.

### The Submission Portal

As indicated above, the submission portal 102 provides the user 101 with an interface to submit user information and enables the user 101 to provide her user information to multiple database operators 108. The user 101 can be an individual or an organization.

In some implementations, the submission portal 102 is an interactive website. The user 101 can interact with the submission portal 102 to submit her user information. For example, the user 101 can submit (a) contact information, such as her first, middle and last name, mailing address, email address, shipping address, and/or phone number, (b) personal/biographical information, such as her educational information or medical insurance information, and/or (c) behavioral information, such as her shopping preferences or other personal behavioral updates.

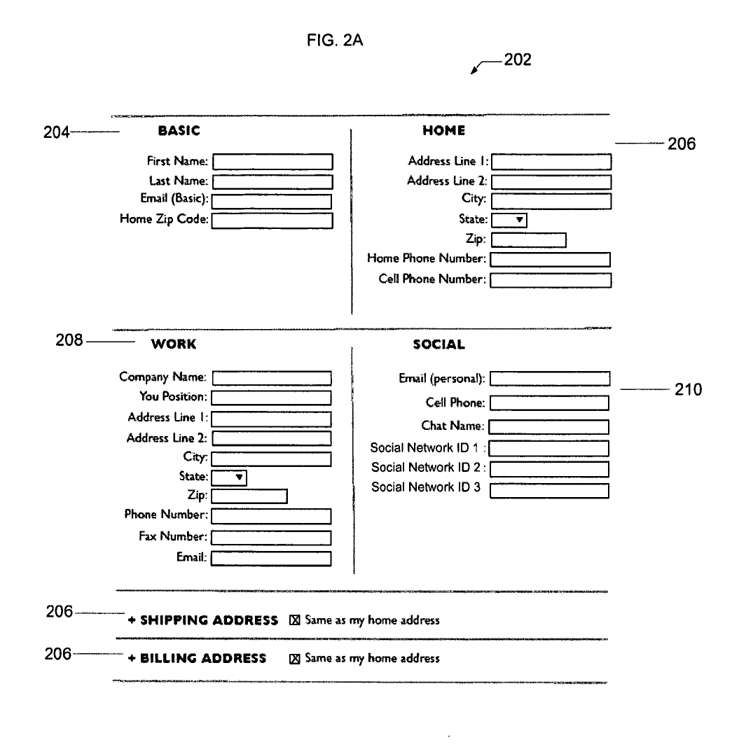

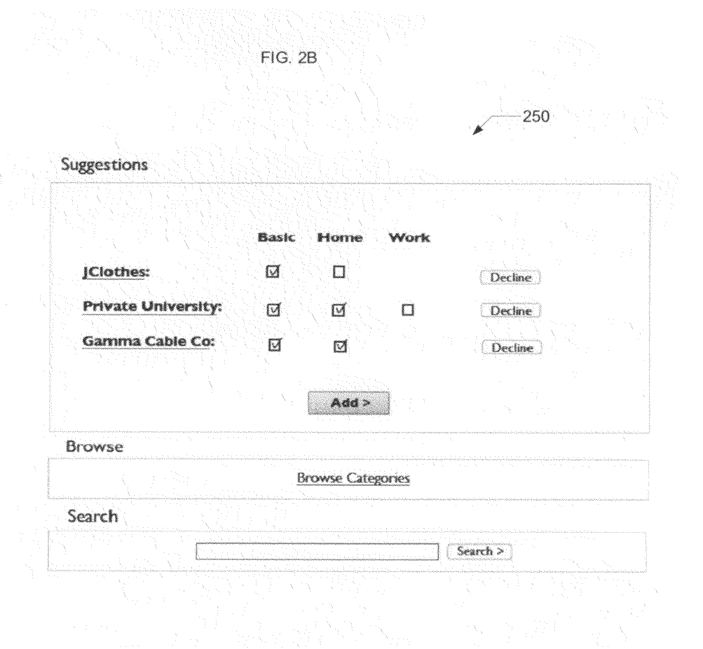

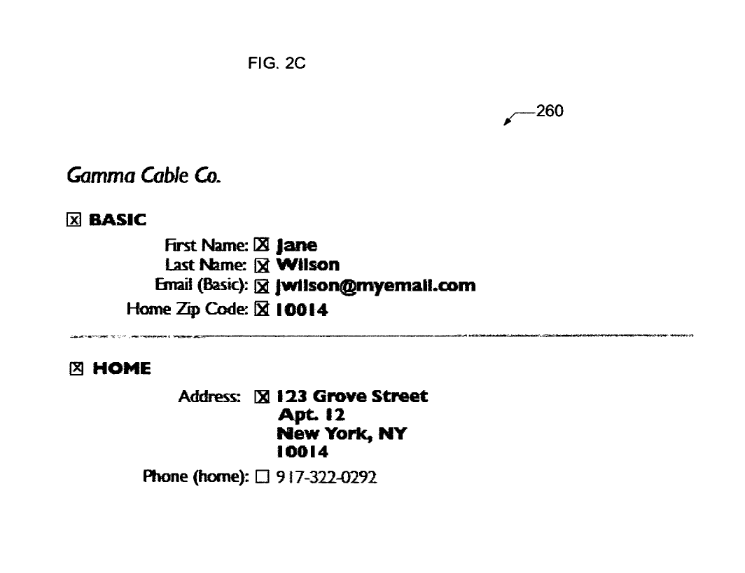

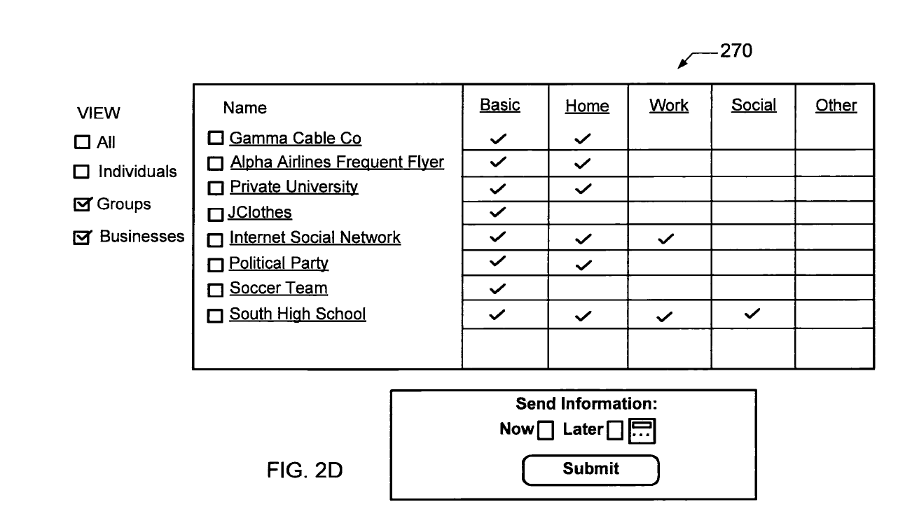

FIG. 2A illustrates an example user information input interface 202 that allows the user 101 to enter certain categories of her user information. In some implementations, the user information input interface 202 includes a basic information section 204, address sections 206, a work information section 208, and a social information section 210. The information can be entered, for example, using a keyboard or other data entry device. Likewise, other interactions between the user 101 and the interface 202 or the submission portal 102 can be made through a keyboard or other device (e.g., an electronic mouse, a touch screen, etc.).

The basic information section 204 allows the user 101 to enter information such as her first and last name and a primary email address. The address sections 206 allow the user 101 to enter her home address, billing address and shipping addresses and phone numbers associated with each of the addresses. The work information section 208 allows the user 101 to enter information related to her employment. For example, the user 101 can enter her employer's name, her title, employer's address and/or other business related information. The social information section 210 allows the user to enter information such as alternate email addresses, instant messaging screen-names and alternate phone numbers.

The user 101 can manage the amount of user information that she provides to the submission portal 102. For example, the user 101 can choose the categories of user information, and the fields within each category, that she wishes to provide. The user 101 can provide, for example, the name and address of her employer but choose not to provide a work phone number. The user 101 can return to the user information input interface 202 at a later time to modify the user information and/or add or remove user information. For example, if the user 101 selects to share her work information with a certain database operator 108 but has not yet provided her work information, the submission portal 102 can prompt the user 101 to return to the user information input interface 202 to input work information. The user information input interface 202 can include buttons (such as “save” or “next”) that the user 101 can use to submit her user information to the core system 105. In some implementations, the core system 105 periodically saves the input user information (i.e., auto-save).

In some implementations, the submission portal 102 provides the user 101 with an interface to browse a list of database operators 108. The submission portal 102 can display a list of all database operators 108 or a partial list of database operators 108. The partial list of database operators 108 can be any portion of the total list of database operators 108. For example, the submission portal 102 can display a list of database operators 108 operating near the user 101's home address or a list of database operators 108 that are located within the same zip code as the user 101. In some implementations, the submission portal 102 allows the user 101 to browse the list of database operators 108 by category of database operator 108 or other filtering methods.

In some implementations, the submission portal 102 provides the user 101 with an interface to search for a particular database operator 108. The user 101 can search for the name of a database operator 108 or can search by some other identifying information such as an email address or phone number associated with the database operator 108. The search request is transmitted to the core system 105, which performs the search. The core system 105 transmits the search results to the submission portal 102, which displays the results to the user 101.

If the particular database operator 108 is found, the submission portal 102 allows the user 101 to select to share user information with the database operator 108. In some implementations, if the core system 105 does not identify a database operator matching the user 101's query (an “unknown database operator”), the submission portal 102 allows the user 101 to select to share user information with the unknown database operator and the core system 105 and/or administrators of the system 100 can attempt to contact the unknown database operator. The submission portal 102 can then inform the user 101 at a later time, through the submission portal 102 or otherwise, if the user information was successfully shared with the unknown database operator.

In some implementations, the submission portal 102 provides the user 101 with a suggested recipients interface that displays one or more database operators 108 as potential recipients of the user 101's user information (i.e., suggested recipients). The suggested recipients can be chosen based on the user 101's user information (e.g., zip code or email address). The suggested recipients interface can display numerous potential recipients for the user information of user 101 and can eliminate the need for user 101 to browse or search for all of the database operators 108 with which the user 101 wishes to share her user information.

The submission portal 102 also can display the type(s) of information requested by each database operator 108 (“requested information”). For example, a first database operator 108 can request the user 101's basic information and work information and a different database operator 108 can request the user 101's basic information and her home address. As described below, each database operator 108 can request different categories of user information.

The submission portal 102 allows the user 101 to select the database operators 108 with which the user 101 wishes to share her user information (“designated recipients”) and to select the categories and/or particular items of her user information that she wishes to share with each designated recipient (“user selections”). FIG. 2B illustrates an example selection interface 250 that allows the user 101 to select database operators 108 with which the user 101 wishes to share her user information. In addition, the selection interface 250 allows the user 101 to select the amount of user information that is shared with each database operator 108. The user 101 can review each database operator 108's requested information and select the categories of the requested information that she wishes to share. For example, as shown in FIG. 2B, the user 101 can decide that JClothes should receive only her basic information (e.g., her name and email), that Private University should receive her basic information and her home address information, but not her work information, and that Gamma Cable Co. should receive her basic information and her home address information.

In some implementations, the user 101 can control the particular items of user information that she wishes to share with a database operator 108. FIG. 2C illustrates an example detailed selection interface 260 for the user 101 to select the particular items of her user information that she wishes to share with a particular database operator 108. As shown in FIG. 2C, the user 101 can choose, for example, to share her basic information and only a portion of her home address information with Gamma Cable Co. (i.e., only her home address and not her home phone number). Thus, within each category of user information, the user 101 can select the particular items of user information that she wishes to share with each database operator 108.

FIG. 2D illustrates an example summary interface 270 that allows a user 101 to view a list of the database operators 108 that the user 101 has selected as designated recipients and the corresponding user selections. The user 101 can modify the categories of user information that each database operator 108 is permitted to receive and can remove or add database operators 108 to the list of designated recipients at any time. Over time, if the user 101 shares her user information with additional database operators 108, the names of the additional database operators 108 and the corresponding user selections can be automatically added to the list.

The interfaces 250, 260 and 270 can each include buttons (such as “save”, “add” or “submit”) that the user 101 can use to submit her designated recipients and user selections to the core system 105. In some implementations, the core system 105 periodically saves the designated recipients and user selections (i.e. auto-save).

In some implementations, the submission portal 102 can provide a final submission button for the user 101 to submit the list of designated recipients and corresponding user selections to the core system 105. These confirmed user selections determine the contents of the data feeds that are provided to the database operators 108.

In some implementations, the submission portal 102 can notify the user 101 when a designated recipient accesses her user information and/or updates their database 114 and/or records. For example, after the user 101 submits her user information, designated recipients and user selections to the core system 105, the summary interface 270 can indicate which database operators 108 have received her user information and which have not (i.e., which are still pending).

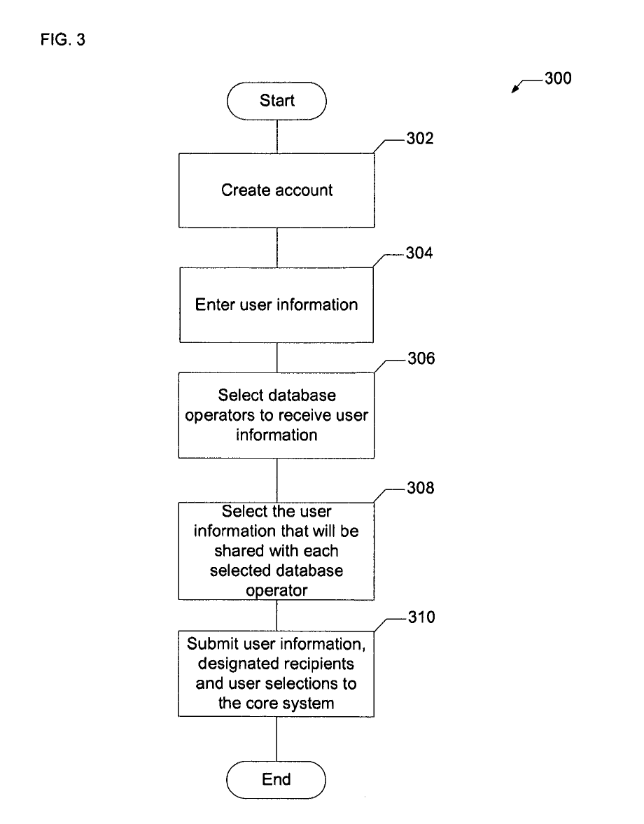

FIG. 3 illustrates an example user experience 300. The user 101 first creates an account with the submission portal 102 (block 302). The user 101 can choose a login ID and password.

After the user 101 creates an account, the user 101 then enters her user information (block 304). The user 101 can enter as much or as little user information as she chooses and the user 101 need not complete each displayed category. After the user inputs her user information, it is submitted to and stored in the core system 105.

The user 101 then selects database operators 108 to receive her user information (block 306). For example, the user 101 can select database operators 108 by browsing a list of database operators 108, searching for database operators 108 or selecting suggested database operators 108.

For each database operator 108, the user 101 can review each database operator 108's requested information and select the amount of user information that she wishes to share with the database operator 108 (block 308). For example, referring to FIG. 2B, the user 101 can decide that J Clothes should receive only her basic information (e.g., her name and email) and that Gamma Cable Co. should receive her basic information and her home address. The user 101 then submits her final or confirmed user information, designated recipients and user selections to the core system 105 (block 310). The core system 105 then provides the selected user information to the designated recipients.

In some implementations, the user 101 can control the frequency at which certain database operators 108 send mailings or catalogs to the user 101. For example, the user 101 can request that a database operator 108 only send the user 101 catalogs or brochures at or near the holidays. Such a request can be transmitted to the database operator 108 along with the user information in the database operator 108's data feed.

The user 101 can return to the submission portal 102 and update her user information and/or modify her designated recipients and user selections. For example, the user 101 can use the summary interface 270 to review and/or modify the designated recipients and the particular categories of her user information that she wishes to share with each database operator 108. When user information changes, the user 101 can input new or updated user information and efficiently share the new or updated user information without having to reselect the designated recipients and corresponding user selections.

### The Core System

As noted above, the core system 105 includes one or more servers 104 and one or more databases 110 that are connected to the server(s) 104. The server(s) 104 can be, but is not limited to, any type of dedicated server or personal computer.

The database(s) 110 can be contained within the server(s) 104 or can be in a separate storage device or computer. The database(s) 110 can store information received from the submission portal 102 and the feed portal 106. For example, the database(s) 110 can store (1) one or more lists of the database operators 108 that are recognized by the system 100 and information related to each of the database operators 108, (2) information received from the submission portal 102, such as a user 101's user information, designated recipients and corresponding user selections, and submission portal account information, and (3) information received from the feed portal 106, such as a database operator 108's requested information.

The core system 105 is connected to the submission portal 102 and the feed portal 106. The connections can be any type of network connection such as an Ethernet connection, a digital subscriber line (DSL) or a telephone line. The core system 105 receives user information, designated recipients, user selections and other data via the connection between the server(s) 104 and the submission portal 102. The core system 105 stores the user information, designated recipients, user selections and other data in the database(s) 110. In addition, the core system 105 transmits data, such as the requested information of a database operator 108, to the submission portal 102.

The core system 105 is also connected to the feed portal 106 and transmits data, such as a user 101's user information, from the database 110 to the feed portal 106. In addition, the core system 105 can receive data, such as a database operator 108's requested information, via the connection between the server(s) 104 and the feed portal 106. The core system 105 can store data received from the feed portal 106 in the database(s) 110.

In some implementations, the core system 105 can analyze a user 101's user information and suggest database operators 108 with whom the user 101 may already have an existing relationship or with whom the user 101 may want a relationship. For example, the core system 105 can analyze user 101's zip code associated with her home address to determine the local utility providers with whom the user 101 probably has a relationship or may want a relationship. The core system 105 can then provide the submission portal 102 with these suggested database operators 108.

The core system 105 can receive search queries for particular database operators 108 submitted by a user 101 through the submission portal 102. The core system 105 can analyze a list or database of recognized database operators 108 and search for a database operator 108 that satisfies the search criteria submitted by the user 101. After the search is performed, the search results are transmitted to the submission portal 102.

In some implementations, the core system 105 monitors the frequency at which a database operator 108 interacts with the feed portal 106 and/or reviews or accesses its data feed. In some implementations, if the core system 105 determines that the database operator 108 has not recently interacted with the feed portal 106 and/or accessed its data feed, the core system 105 can notify the database operator 108. For example, if the core system 105 determines that more than two weeks have passed since a database operator 108 last accessed its data feed, the core system 105 can send the database operator 108 an email or other notification urging the database operator 108 to review its data feed. In some implementations, the core system 105 can send a database operator 108 an email or other notification that explains that there is new and/or updated user information available to the database operator 108 and which has not yet been accessed.

### The Feed Portal

In general, the feed portal 106 allows a database operator 108 to access user information that users 101 selected to share with the database operator 108. In some implementations, the feed portal 106 is an interactive website that allows each database operator 108 to access and manage its respective data feed. In some implementations, secure access to the feed portal can be provided through Secure Hyper Text Transfer Protocol (“HTTPS”) and/or the use of authentication devices similar to an RSA Secure ID. The feed portal 106 can include interfaces for the database operators 108 to interact with the core system 105 and receive user information, manage the method by which they receive the user information, and/or manage the type of user information that they receive.

Database operators 108 can interact with the feed portal 106 and create an account with the feed portal 106. The database operators 108 can create a login and password. In some implementations, database operators 108 can specify or be given a unique URL, which is an Internet sub-domain associated with the feed portal 106. Each unique URL, once activated, can serve as the database operator 108's gateway to access the functionalities of feed portal 106. In some implementations, each database operator 108 can login and accesses the feed portal 106 from the same URL.

Any database operator 108 can create an account on the feed portal 106 and receive user information through the feed portal 106. Also, every database operator 108 is a potential recipient of user information. For example, the submission portal 102 and/or the core system 105 allows a user 101 to designate any database operator 108 as a recipient of her user information regardless of whether the database operator 108 has previously interacted with the system 100 and/or created an account with the feed portal 106.

In some implementations, if a user 101 designates a database operator 108 as a recipient of her user information and the database operator 108 has not previously interacted with the feed portal 106, the core system 105 can attempt to contact the database operator 108. For example, the core system 105 can generate a message, such as an email, that is sent to the database operator 108. The email can contain the user 101's user information and/or a notification that one or more users 101 have attempted to share their user information with the database operator 108. Thus, in some implementations, a database operator 108 can receive user information from the core system 105 regardless of whether it has previously interacted with the feed portal 106.

In some implementations, the feed portal 106 and/or the core system 105 includes various verification steps to ensure that a database operator 108's feed portal account is activated and accessed only by appropriate individuals associated with the database operator 108. For example, the feed portal 106 can require that a database operator 108 activate its feed portal account by confirming access to certain email addresses associated with the known primary web address of the database operator 108.

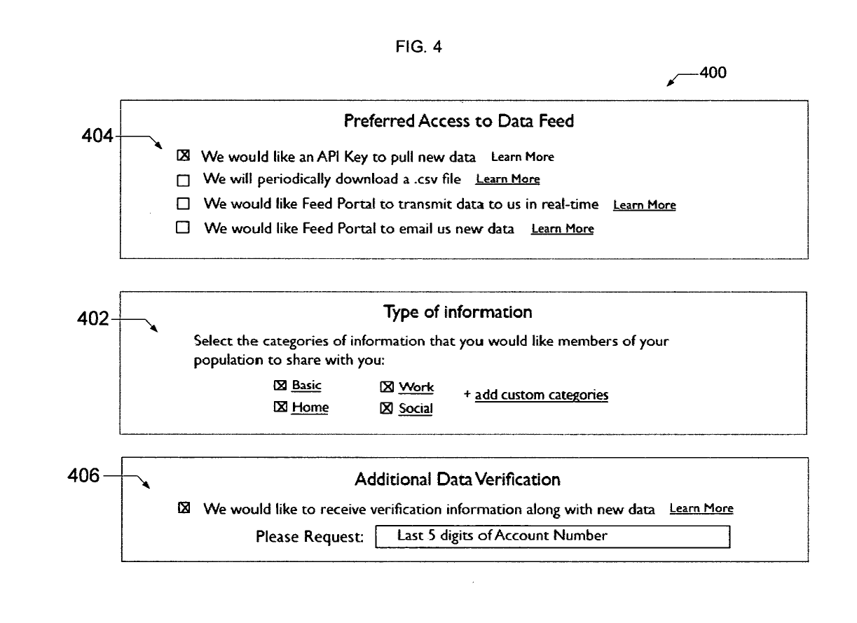

Each database operator 108 can specify its requested information. FIG. 4 illustrates an example feed portal interface 400 that includes an interface section 402 for a database operator 108 to specify its requested information. A database operator 108 can use the interface section 402 to specify the particular categories of user information that the database operator 108 wishes to receive from the users 101. For example, one database operator 108 may request basic information and work information from users 101 and a different database operator 108 may request basic information and home address information from users 101. The particular categories requested by a database operator 108 will be displayed on the submission portal 102 for users 101. In addition, the feed portal 106 allows the database operators 108 to create custom categories of information to request from users 101.

The feed portal 106 enables each database operator 108 to access its respective data feed. The data feed can be in any format, including formats specified by the database operator 108. Database operators 108 do not have to verify their relationship with users 101 before receiving user information of users 101. Instead, each database operator 108 receives its data feed, which includes user information of certain users 101, based on the decisions of certain users 101 to select the database operator 108 as a designated recipient using the submission portal 102.

A database operator 108's data feed includes user information of the users 101 that selected the database operator 108 as a designated recipient. For example, a user 101 can select that a first database operator 108 receive her user information but does not select a different database operator 108 to receive her user information. As a result, only the data feed of the first database operator 108 will include the user information of the user 101. In addition, the data feed of the first database operator 108 will include the particular categories or items of user 101's user information that correspond to user 101's user selections for the first database operator 108.

Only database operator 108 can access the data feed intended for the database operator 108. It should be noted that the core system 105, or an administrator of the core system 105, can access database operator 108's data feed.

In some implementations, each database operator 108's data feed changes and/or updates in real-time as users 101 submit new or updated user information and/or modify their designated recipients and user selections through the submission portal 102.

The feed portal 106 can provide different methods for a database operator 108 to access its data feed. For example, the feed portal 106 can (1) transmit the data feed to the database operator 108 (i.e., push the data feed), (2) allow the database operator 108 to request delivery of its data feed (i.e., pull the data feed), (3) send the data feed to the database operator 108 in a message or email, (4) allow the database operator 108 to download a file containing the data feed and/or (5) provide an interface for the database operator 108 to review and capture the data feed FIG. 4 shows an example interface 400 that includes an interface section 404 that allows a database operator 108 to choose a method that is most convenient or efficient for the database operator 108 to accesses its data feed. For example, a first database operator 108 may prefer to periodically request its data feed by means of an application programming interface (“API”), while a second database operator 108 may prefer to periodically log into its account with feed portal 106 and download a file that contains its data feed. The database operators 108 can interact with the interface 400 and the feed portal 106 using a keyboard, electronic mouse or any other input device.

In some implementations, the feed portal 106 and/or the core system 105 can automatically transmit a data feed to a database operator 108. In other words, the feed portal 106 and/or the core system 105 can be configured to push new or updated user information to the database operator 108. In some implementations, the feed portal 106 and/or the core system 105 can push data to a database operator 108 at a high frequency or as new or updated information is provided to the core system 105 (i.e., in real-time). In some implementations, the database operator 108 designates an external location point (such as an API or database) to which the feed portal 106 and/or the core system 105 will push the applicable data feed. In some applications, a bridge application can link the core system 105 to the backend of the database operator 108's database infrastructure. Further, the database operator 108 can configure the data feed to automatically update its user records stored in its database 114. Thus, the database 114 can be configured to update automatically as the database operator 108's data fee changes on account of users 101 submitting new or updated user information and/or modifying their designated recipients or user selections through the submission portal 102. As an example, an intermediary database can be configured to receive the real-time data feed from the feed portal 106 and/or the core system 105. The intermediary database can periodically or continuously synchronize with the database 114 of the database operator 108.

In some implementations, a database operator 108 can periodically request its data feed from the feed portal 106 and/or the core system 105. For example, the database operator 108 can use an API associated with the feed portal 106 to request (or pull) its data feed from the feed portal 106 and/or the core system 105. In addition, the database operator 108 can configure its database 114 to automatically update with the new or updated user information received from the feed portal 106 and/or core system 105. The database operator 108 can control the frequency at which it requests its data feed. In some implementations, the database operator 108 can adjust the response format (i.e., the format for the data feed) on a per API call (or request) basis.

In some implementations, a database operator 108 can query the feed portal 106 and/or the core system 105 to determine whether its data feed contains new or updated user information that the database operator 108 has not yet received. For example, the database operator 108 can use an API associated with the feed portal 106 to request a response from the feed portal 106 and/or the core system 105 that indicates whether or not there are new updates to its data feed since the previous time it accessed its data feed. In addition, the database operator 108 can use the API to request that the feed portal 106 and/or the core system 105 provide only the new or updated user information that has been added to its data feed since the previous time that the database operator 108 accessed its data feed.

In some implementations, a database operator 108 can download a file containing its data feed through a feed portal interface. The file can be any type of computer readable file, such as a comma separated value (.csv) file or a Microsoft Excel spreadsheet. The database operator 108 can then update its database 114 using the contents of the file. The database operator 108 can specify which user information it wishes to receive in the file. For example, the database operator 108 can request only new or updated user information that has been added to its data feed during the past week or since the last time that the database operator 108 downloaded a file.

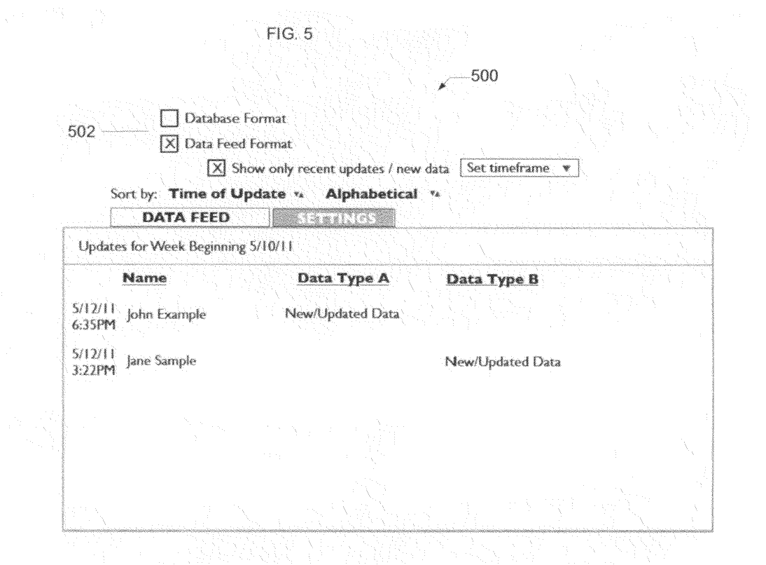

In some implementations, the feed portal 106 allows a database operator 108 to review its data feed using a feed portal interface. FIG. 5 illustrates an example data access interface 500 that includes controls 502 for the database operator 108 to select the display format and options to sort the data, such as by time period. The data access interface 500 allows the database operator 108 to review new and/or updated user information from the relevant time period selected by the database operator 108. The database operator 108 can choose to access its data feed through the data access interface 500 and then manually update its database 114 with the new and/or updated user information.

In some implementations, a database operator 108 can use the data access interface 500 as an auto-updating database that supplements or replaces its database 114. For example, the database operator 108 can use the data access interface 500 as a database that is accessible through the feed portal 106 using any computer.

In some implementations, a database operator 108 can request that the feed portal 106 send messages, such as emails, that include new or updated user information in the database operator 108's data feed.

In some implementations, the feed portal 106 can provide a database operator 108 with statistics about its data feed. For example, the feed portal 106 can provide the database operator 108 with statistics related to the number of users 101 that have designated the database operator 108 as a recipient and/or that have submitted new or updated user information since the database operator 108 last interacted with the feed portal 106 or accessed its data feed.

In some implementations, the feed portal 106 can alert a database operator 108 when a particular user 101 updates her user information or provides new user information but chose not to share the new or updated user information with the database operator 108 (a “negative feed”). A negative feed allows the database operator 108 to learn that the user information associated with the particular user 101 stored in its database 114 may have become inaccurate. For example, the core system 105 can determine whether the user 101 previously selected to share certain user information with the database operator 108 but chose not to share updates to such user information with the database operator 108. As another example, the core system 105 can recognize that the user 101 has a relationship with the database operator 108 because certain items of the user 101's user information matches information in a membership list uploaded by the database operator 108.

In some implementations, a user 101 can prevent the feed portal 106 and/or the core system 105 from generating negative feeds regarding changes to her user information. For example, the user 101 can use various controls and options provided by the submission portal 102 to configure her submission portal account such that negative feeds are not generated.

Additional features and capabilities of the system 100 are described below.

### Suggested Recipient

As indicated above, the core system 105 can analyze a user 101's user information to suggest database operators 108 to the user 101. In some implementations, the core system 105 receives information from a database operator 108 and uses this information to determine if the user 101 is likely to have an existing relationship with the database operator 108. Also, the core system 105 can utilize the geographical location of the user 101 to determine potential database operators 108 with which the user 101 may have or want a relationship. Thus, the submission portal 102 can provide the user 101 with a list of database operators 108 with which the user 101 may have or want a relationship (i.e., suggested recipients). By presenting the user 101 with a list of suggested recipients, the user 101 is spared from searching for particular database operators 108 and is less likely to forget to provide her user information to these database operators 108.

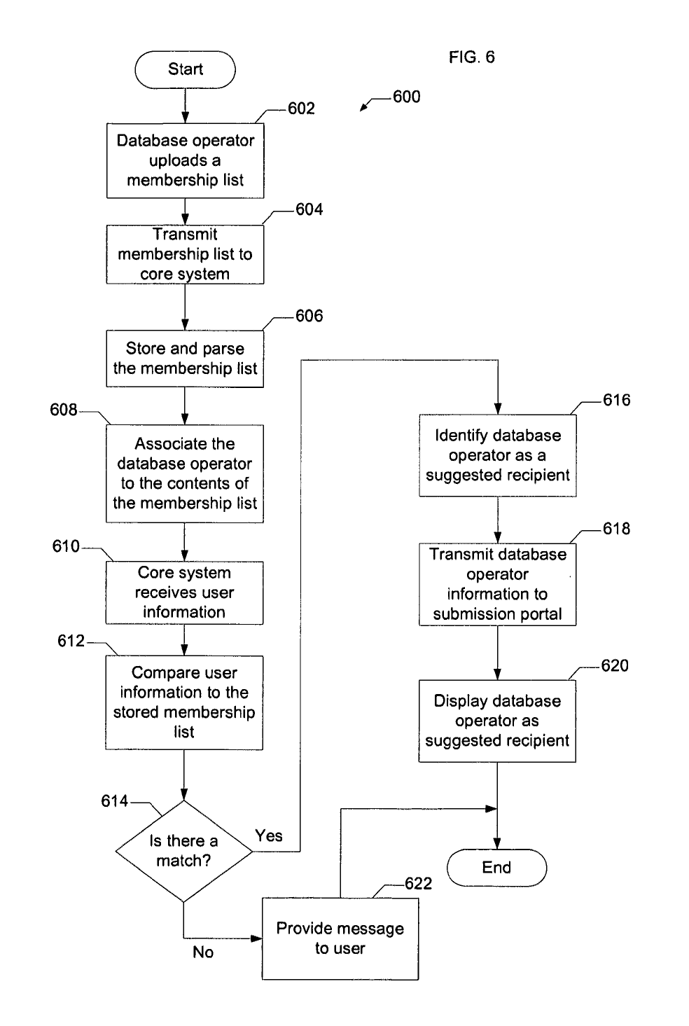

FIG. 6 is a flow chart illustrating an example method to determine if a particular database operator 108 should be presented to a user 101 as a suggested recipient. The database operator 108 uploads a file containing information identifying the database operator 108's membership population (e.g., a membership list, a client list or a customer list) to the feed portal 106 (block 602). For ease of discussion, the term “membership list” will be used to refer to the file containing information identifying the database operator 108's membership population. For example, the database operator 108 can upload a membership list that includes the name of the database operator 108's members and other information about each member such as the members' email addresses, home addresses, telephone numbers, account numbers, membership enrollment dates, service start dates, or other personal identifying information.

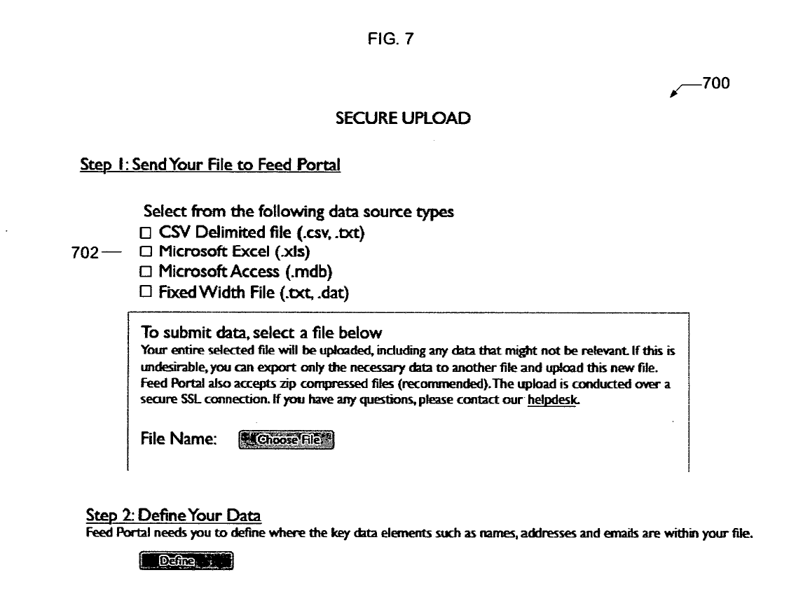

The database operator 108 can upload the membership list in various formats. For example, the membership list can be a comma separated value file (.csv format), a Microsoft Excel spreadsheet (.xls format), a Microsoft Access file (.mdb format), or a fixed width text file (e.g., .txt or .dat). FIG. 7 shows an example interface 700 for a database operator 108 to upload a membership list. The example interface 700 includes controls to select the format of the membership list and/or explain its contents.

The server(s) 104 transmits the membership list from the feed portal 106 to the core system 105 (block 604). The server(s) 104 stores the membership list in the database(s) 110 and parses the contents of the membership list to identify each member in the membership list and the member's associated information (block 606). Each member and his/her uploaded information is then associated by the server(s) with the database operator 108 that uploaded the membership list (block 608). For example, a descriptor or other token that identifies the database operator 108 can be appended or attached to the member's information to indicate that the member is associated with the database operator 108.

The core system 105 receives user information of the user 101 from the submission portal 102 (block 610). The core system 105 then analyzes and compares the user information to the stored membership information (received from database operator 108) to determine if the user 101 has a relationship with the database operator 108 (i.e., the user is member of the membership list) (block 612). The core system 105 can compare each item of the user information to the membership information or can compare particular items of the user information to the membership information. For example, the core system 105 can compare the user 101's name and email address to the stored membership information to determine if the user 101 is a member of the membership list. The core system 105 also compares the user information to other membership lists stored in the database 110 to determine if the user 101 has a relationship with any other database operator 108.

If the core system 105 determines that the user information matches stored membership information (block 614), the core system 105 identifies the database operator 108 associated with the membership information as a suggested recipient for the user 101 (block 616). The server(s) 104 then transmits information about the database operator 108 (e.g., the database operator's name and requested information) to the submission portal 102 (block 618).

The submission portal 102 then displays the database operator 108's name to the user 101 as a suggested recipient and displays the categories of user information that the database operator 108 requested (block 620). The user 101 can decide whether to provide her user information to the database operator 108. In addition, the user 101 can select particular categories of requested information to provide to the database operator 108.

If the core system 105 determines that the user information is not included in any of the membership lists, the submission portal 102 provides the user 101 with a message indicating that there are no suggested recipients or displays suggested recipients based on the user's geographic location. (block 622).

As indicated above, the core system 105 can analyze the user 101's geographical information to determine suggested recipients. For example, the core system 105 can analyze the zip code of the user's home address and determine which database operators 108 operate in the geographic area near the user's zip code (e.g., a local utility company). The core system 105 can then transmit the names of these database operators 108 and their requested information to the submission portal 102.

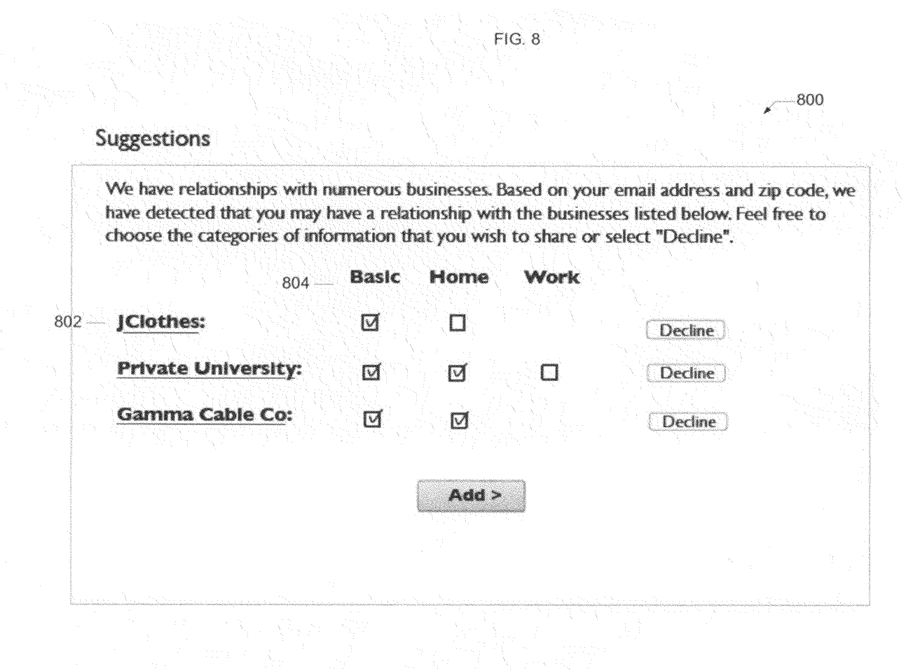

FIG. 8 illustrates an example suggested recipient interface 800 that displays the list of suggested recipients 802 to the user 101. In addition, the suggested recipient interface 800 can display the categories of user information 804 requested by each suggested recipient. The suggested recipient interface 800 also servers as a selection interface and thus allows the user 101 to grant the suggested recipients access to her user information and select which items of her user information each suggested recipient can access.

### Information Requests

In some implementations, a database operator 108 can use the feed portal 106 to request user information from a user 101 or from a person who is not registered with the submission portal 102 (collectively, “individuals”). For example, the feed portal 106 and/or the core system 105 can generate an email for a database operator 108 to send to members of its population. The email request can include a hyperlink that is generated by the feed portal 106 and/or the core system 105 specifically for the database operator 108. After receiving the email, the individual can click on the hyperlink and access an interface that enables the individual to share selected categories of user information with the database operator 108 using modified submission portal forms, which are described below.

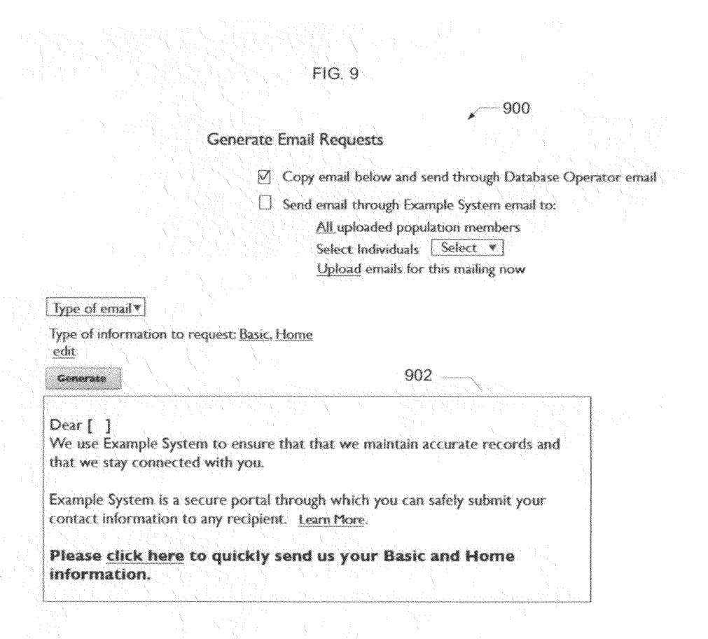

In some implementations, the feed portal 106 provides a user interface that allows a database operator 108 to access an email request generated by the feed portal 106 and/or the core system 105. In some implementations, the interface allows the database operator 108 to choose a template for the email request. For example, FIG. 9 illustrates an example email interface 900 to access and edit email requests. The database operator 108 can use the email interface 900 to review and edit a template email request 902 and/or specify its requested information. In some implementations, the email includes a link to the database operator 108's privacy policy, a summary of its privacy policy, and/or a visual trust indicator related to its privacy policy, which is explained below.

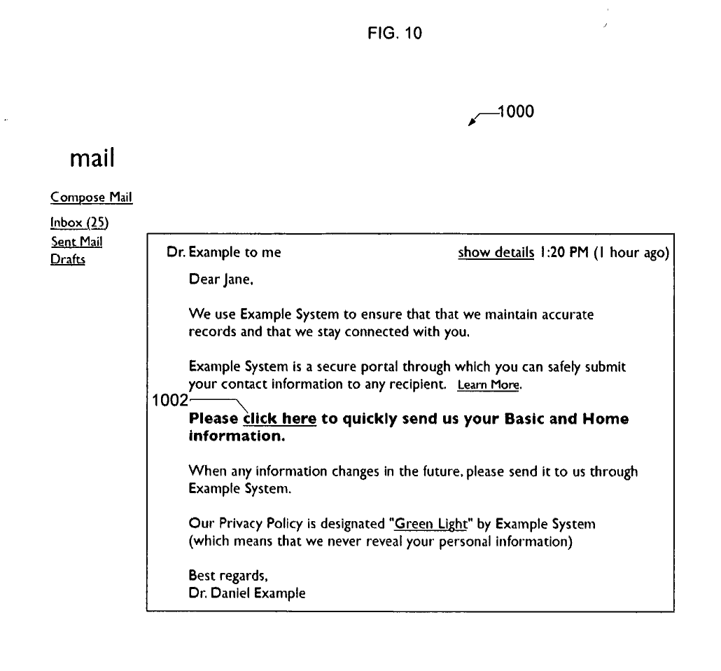

FIG. 10 illustrates an example email request 1000. The email request 1000 includes the hyperlink 1002 generated by the feed portal 106 and/or the core system 105 specifically for the database operator 108. In some implementations, when the individual clicks the hyperlink 1002, the individual is presented with modified submission portal forms. The modified submission portal forms provide the individual with certain submission portal 102 functionalities, such as entering her user information and/or submitting her user information to the requesting database operator 108. The modified submission portal forms are described below.

In some implementations, a database operator 108 can export the generated email request, which includes the custom hyperlinks tailored for the database operator 108, to its own email system to send the message. For example, the database operator 108 can copy the email message and then paste it into its own email system.

In some implementations, the feed portal 106 can enable a database operator 108 to send the email request to certain individuals through an email service affiliated with the system 100. For example, the database operator 108 can send the email request to certain uploaded email addresses through an email server/service associated with the system 100.

In some implementations, the core system 105 can integrate with a third-party email vendor. For example, the core system 105 can be configured to integrate with a third party email service to enable the third party to send, on behalf of the database operator 108, the email request generated by the feed portal 106 and/or the core system 105. For example, after the database operator 108 finalizes an email request using the email interface 900, the core system 105 can transmit to the third party email vendor a list of email addresses of the individuals from whom the database operator 108 seeks user information, the content for the email message which includes the custom hyperlink, and a schedule for delivery of the email message.

### Linking Website to Submission Portal

In some implementations, a database operator 108 can include a hyperlink or an embedded application (e.g. a widget or a website link widget) that interacts with the submission portal 102 on a website that is owned, operated or otherwise affiliated with the database operator 108 (“the database operator's website”). The embedded application can be implemented using internet programming languages such as Java, Javascript, CGI, or ASP. For example, the database operator's website can include a modal window with an iframe that allows an individual to interact with the submission portal 102.

In some implementations, the feed portal 106 and/or the core system 105 can generate the hyperlink, embedded application and/or other similar technology (collectively referred to as a “website widget”) for each database operator 108. A database operator 108 can download, request or access the website widget through the feed portal 106 and then host it on the database operator's website. The website widget, when clicked by an individual with an electronic mouse or other input device, presents the individual with modified submission portal forms, which allow the individual to share user information with the applicable database operator 108. The modified submission portal forms are described below.

In some implementations, the website widget can appear on a database operator's website in the shape or branding of the submission portal 102 and/or the system 100. In some implementations, the feed portal 106 can provide certain control options for the database operator 108 to customize its website widget. For example, the database operator 108 can choose for the widget and/or the modified submission portal forms to be closely branded to the database operator's website.

### Modified Submission Portal Forms

The website widgets and the email request hyperlinks generated by the feed portal 106 and/or the core system 105 both provide remote access to modified submission portal forms (i.e., web-based forms associated with the submission portal 102). The modified submission portal forms are custom-generated by the core system 105 for each database operator 108 and are designed to enable swift transmission of user information from the individual to the database operator 108 that sent the email request or hosted the website widget. The modified submission portal forms are submission portal 102 interfaces, such as user information input interfaces and selection interfaces, that are modified to enable the individual to share user information with a particular database operator 108. For example, a user information input interface on a modified submission portal form may be customized to only include categories that match the database operator 108's requested information. Similarly, a selection interface on a modified submission portal form may only enable the individual to select the applicable database operator 108 as a designated recipient.

In addition, the modified submission portal forms can allow the user 101 to perform many of the functions available to the user 101 directly on the submission portal 102. For example, a modified submission portal form can allow a user 101 to log in to the submission portal 102 and can provide Internet links to access standard submission portal 102 interfaces.

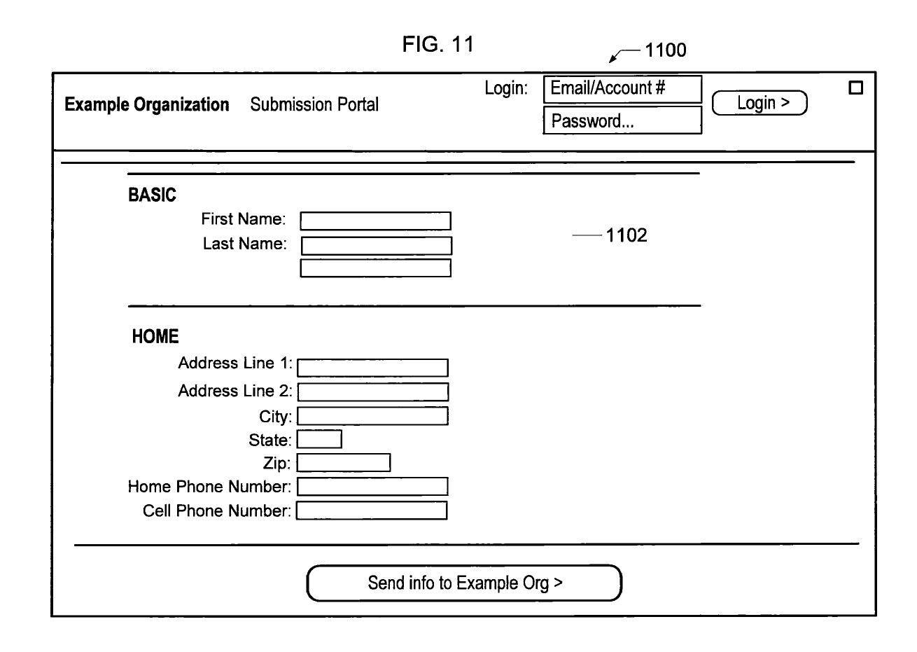

FIG. 11 is an example modified submission portal form 1100. The modified submission portal form 1100 can be accessed, for example, from a website widget or email hyperlink. The modified submission portal form identifies the database operator 108 that is requesting the user information. For example, the modified submission portal form 1100 identifies Example Organization as the database operator 108 that is requesting user information. In addition, the modified submission portal form 1100 includes an interface section 1102 that identifies the particular items of user information that the database operator 108 has requested. For example, as illustrated in FIG. 11, Example Organization's requested information is basic information and home information. The interface section 1102, which is a modified user information input interface, allows the user 101 to input her user information (in the categories requested by the database operator 108) and share her user information with the database operator 108.

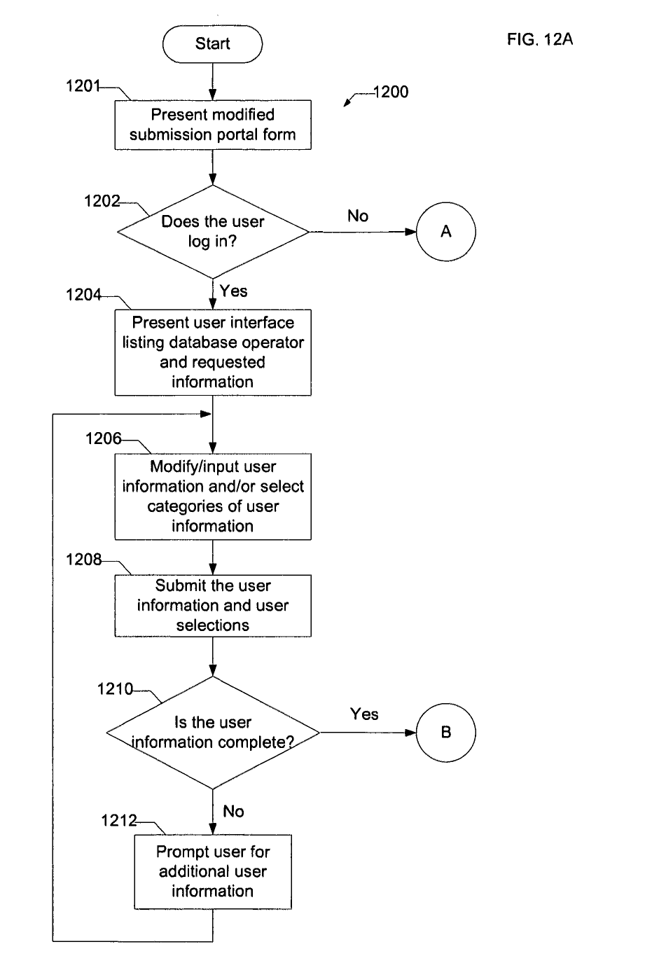

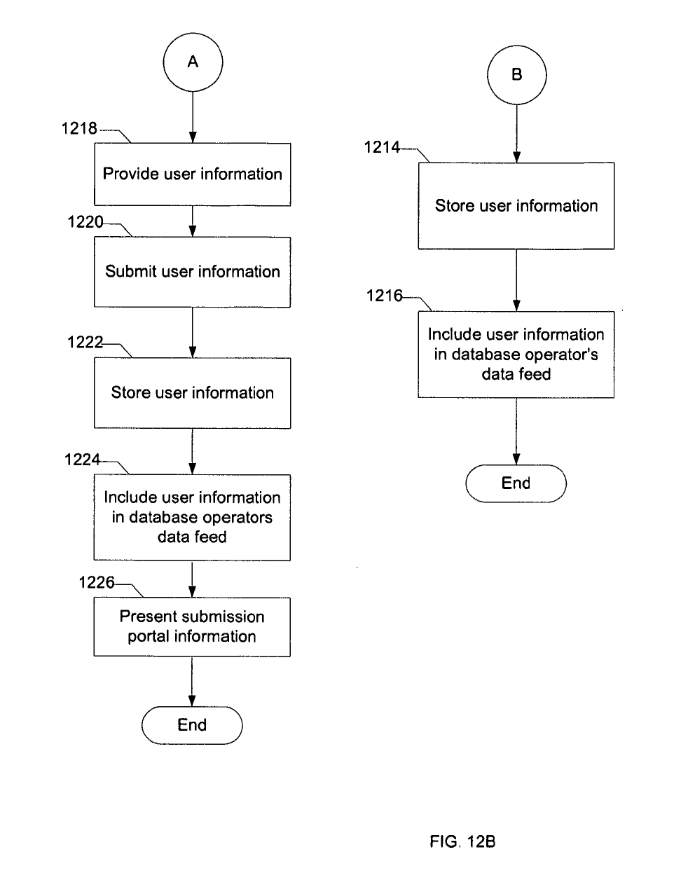

FIGS. 12A and 12B are flow charts illustrating an example user interaction with the modified submission portal forms. After the user 101 clicks on the website widget or the hyperlink included in an email request, the user 101 is presented with a modified submission portal form (block 1201). The modified submission portal form can allow the user 101 to log in to her submission portal account or interact with a modified user information input interface and provide her user information.

If the user 101 logs in to her submission portal account (block 1202), the modified submission portal form will present the user 101 with an interface that lists the database operator 108 that is requesting information from the user 101 and the categories of information that the database operator 108 is requesting (block 1204). This interface can be a modified selection interface, and thus only lists the applicable database operator 108 and its requested information. The user 101 can interact with the interface and select the categories of user information, if any, she wishes to share with the database operator 108 (block 1206). In addition, the user 101 can review and/or modify her previously submitted user information. The user 101 then can submit her user selections to the core system 105 (block 1208).

In some implementations, the submission portal 102 can review the user 101's user information to determine if any of the user information categories that the user 101 has selected to share is incomplete or missing (block 1210). If any such information is incomplete, the submission portal 102 prompts the user 101 to input the missing information (block 1212).

After the user 101 submits her user information and/or user selections, the server(s) 102 stores the user information and/or user selections in the database(s) 110 (block 1214). The server(s) 102 can transmit the user information to the feed portal 106 (block 1216). Thus, after the user 101 submits user information and/or user selections using the modified submission portal forms, the data feed of database operator 108 contains the new or updated user information that the user 101 chose to share with the database operator 108.

If the user 101 does not login to a submission portal account (block 1202), the user 101 can provide her user information on a modified user information input interface that only includes input categories that match the database operator 108's requested information (block 1218). For example, the user 101 can enter her user information in fields provided by the modified submission portal form. The user 101 can then submit her user information to the core system 105 (block 1220). After the user 101 submits her user information, the server(s) 102 stores the user information and user selections in the database(s) 110 (block 1222). The server(s) 102 can transmit the user information to the feed portal 106 (block 1224). Thus, after the new or logged out user 101 inputs user information and user selections, the data feed of database operator 108 contains the new or updated user information that the user 101 chose to share with the database operator 108.

In some implementations, the core system 105 can search its database(s) 110 for the user 101's user information (i.e., to determine if the not logged in user has an account) and update or modify any stored user information with the newly submitted user information. The core system 105 can use any item of user information submitted through the modified submission portal form to identify the user 101's stored user information. For example, the core system 105 can compare an email address submitted through the modified submission portal form with email addresses stored in its database(s) 110 to identify the user 101's user information.

In some implementations, if the core system 105 was unable to identify the user 101's stored user information, the core system 105 will present the user 101 with a website that contains information related to the submission portal 102 (block 1226). The website can include a message thanking the user 101 for submitting her user information and can also provide links to create an account and interact with the submission portal 102.

### Data Verification

In some implementations, the system 100 can verify whether a user 101 has an existing relationship with a database operator 108 and/or whether the user 101 is the individual that she claims to be (i.e., confirm the user's identity). The system 100 can use a business code to verify the identity of the user 101 and her relationship with a database operator 108. A business code could include the last four digits of an account number, a unique key or personal identification number (i.e., “a PIN”), an account activation date, the date service began or other verification information specified by a database operator 108. Each database operator 108 can select one or more business code verification options through the feed portal 106. For example, in FIG. 4, fields 406 on the feed portal interface enable a database operator 108 to select business code verification and specify a business code.

If a database operator 108 has requested a business code verification option and the user 101 has selected the database operator 108 as a recipient for her user information, the submission portal 102 prompts the user 101 to provide the necessary verification information. In some implementations, the verification information can be included along with the user information in the data feed of database operator 108. The database operator 108 can then independently confirm the user's identity.

In some implementations, the database operator 108 can upload the business code verification information through the feed portal 106. The core system 105 can then verify the user 101 on behalf of the database operator 108. In such a case, the data feed can include the verification results along with the user information so that the database operator 108 knows whether the user 101 has been verified.

In some implementations, the system 100 uses an email address or a cellular phone to verify whether a user 101 has an existing relationship with a database operator 108 and/or whether the user 101 is the person that she claims to be. In one implementation, the system 100 can send a text message to the cellular phone or an email message to the email address that the user 101 claims she owns. If the user 101 verifies ownership of that email address or cellular phone number, the core system 105 can then transmit the email address or phone number to the database operator 108 in its data feed and confirm that it has been verified (i.e., owned by user 101). In some implementations, the system 100 can request the user 101's email and login password for an account with another trusted service (e.g., trusted social networking websites or a trusted e-mail service) and can then verify such login information with these third party services to confirm that the user 101 is the owner of the email as claimed.

The database operator 108 can compare the verified email address or phone number with its database records to verify the user 101. In one implementation, if the database operator 108 has uploaded the emails and/or cellular phone numbers of the members of its population, the core system 105 can conduct such verification on behalf of the database operator 108 and inform the database operator 108 in its data feed that the verified email or phone number matches the email or phone number in the database operator 108's records.

Removal from Marketing Lists

In some implementations, the submission portal 102 allows a user 101 to select particular marketing lists, data brokers, or other organizations (collectively, “marketing organizations”) from which the user 101 wants to opt-out or have her user information removed. After the user 101 selects the marketing organizations that she wants to be removed from, the server(s) 104 transmits the request to the database(s) 110. The core system 105, or a system administrator, can contact the applicable marketing organization on behalf of the user 101 to request that the marketing organization remove the user 101's profile and/or user information from its lists. The system 100 can take steps to comply with each marketing organization's removal or opt-out procedures and the submission portal 102 can provide the user 101 with the steps that the user 101 must perform to comply with the removal procedures. For example, the user 101 may need to provide a specific authorization or provide a payment.

Some implementations include one or more of the following advantages. First, the system 100 can reduce or eliminate data decay in the databases 114 of database operators 108. Because the submission portal 102 and the feed portal 106 are connected and the database operators 108 have access to a real-time data feed of updated or new user information, the database operators 108 can maintain accurate records of their respective membership populations. In addition, the database operators 108 can passively receive user information and do not have to poll or otherwise request updated information for certain users 101 from the system 100. For example, a database operator 108 is not required to request that the system 100 provide user information for a certain user 101 or prove that the database operator 108 is permitted to receive the user information of user 101. Rather, the data feed of database operator 108 that can be accessed through the feed portal 106 automatically includes the user information of user 101 if the user 101 designates the applicable database operator 108 as a recipient through the submission portal 102.

Further, users 101 may be more likely to provide updated user information to a larger number of database operators 108 because the submission portal 102 allows users 101 to submit user information efficiently to multiple database operators 108. Furthermore, users 101 are provided with suggested recipients and this can help the users 101 to remember to provide their updated user information to additional database operators 108.

Further, if a large number of the membership population of a database operator 108 uses the submission portal 102, the rate at which the database operator 108 receives updated user information may increase. Also, widespread use of the submission portal 102 can reduce or eliminate administrative costs associated with maintaining accurate information of the membership population of database operator 108. Thus, database operators 108 may encourage, or require, their membership populations to use the submission portal 102. Furthermore, a consortium effect may develop as database operators 108 encourage their membership populations to use the same submission portal 102. In other words, a database operator 108 may benefit from other database operators encouraging use of the submission portal 102, as widespread encouragement will increase the likelihood that members of the population of database operator 108 utilize the submission portal 102.

A number of embodiments of the invention have been described. Nevertheless, it will be understood that various modifications can be made without departing from the spirit and scope of the invention. For example, in some implementations, the submission portal 102 provides the user 101 with visual trust indicators related to a database operator 108's privacy policy (i.e., the database operator's policy regarding the handling of user information) before the user 101 submits her user information through the submission portal 102. These visual trust indicators can be similar to a traffic light, traffic signs or some other format. For example, a yellow light or a caution sign can indicate that the database operator 108's privacy policy is lax and does not provide sufficient protection of the user 101's user information and a green light or an arrow can indicate that the database operator 108's privacy policy includes provisions limiting the disclosure of the user information. The visual indicators can represent the likelihood that the database operator 108 will sell or reveal the user 101's user information.

The appropriate visual indicator can be determined by an analysis of the database operator 108's privacy policy. In some implementations, a consumer privacy expert can analyze the database operator 108's privacy policy and determine which designation is appropriate. In some implementations, database operators 108 can upload key elements of their privacy policy or answer questions related to their privacy policy through the feed portal 106 and the system 100 will determine which designation is appropriate based on the database operator 108's uploaded policy or responses.

Accordingly, other implementations are within the scope of the following claims.

What is claimed is:

1. A system comprising:
a first portal configured to receive user information, wherein the user information comprises at least one of contact data or biographical data associated with a particular user, the first portal further configured to receive user selected information, wherein the user selected information comprises at least a subset of the user information associated with the particular user and identifies a particular database operator to receive the subset of user information;
a core system comprising a server and a database to store the user information and the user selected information;
a data connection configured to transfer the user information and the user selected information received through the first portal to the core system;
a second portal configured to provide the particular database operator with access to a first data feed, wherein the first data feed comprises the subset of user information associated with the particular user and is accessible only by the particular database operator, the second portal further configured to provide a second different database operator with access to a second data feed, wherein the second data feed is accessible only by the second different database operator.

2. The system of claim 1 wherein the user information further comprises user preference information and user behavioral information associated with the particular user.

3. The system of claim 1 wherein the first data feed further comprises a real-time data feed.

4. The system of claim 1 wherein the first data feed is configured to update a database maintained by the particular database operator.

5. The system of claim 1 wherein the core system is further configured to provide the subset of user information to the particular database operator without receiving a request from the particular database operator to provide the user information of the particular user.

6. The system of claim 1 wherein the subset of user information comprises certain items of user information requested from the particular user by the particular database operator and selected by the particular user.

7. The system of claim 1 wherein the first portal is further configured to output privacy information associated with the particular database operator.

8. The system of claim 1 wherein the core system is further configured to receive verification information from the particular user and to analyze the verification information and a business code to confirm the identity of the particular user, wherein the business code is provided by the particular database operator.

9. The system of claim 8 wherein the core system is further configured to provide the verification information to the particular database operator.

10. The system of claim 1 wherein the core system is further configured to:
analyze the user information and predict whether the particular user has a relationship with the second different database operator; and
provide information associated with the second different database operator to the first portal based on the prediction.

11. The system of claim 10 wherein the core system is configured to predict whether the particular user has a relationship with the second different database operator based on identifying user information in a membership list provided by the second different database operator.

12. The system of claim 1 wherein the core system is further configured to:
analyze the user information and predict whether the particular user would desire a relationship with the second different database operator; and
provide information associated with the second different database operator to the first portal based on the prediction.

13. The system of claim 12 wherein the core system is configured to predict whether the particular user would desire a relationship with the second different database operator based on analyzing the user information and a geographic area of operation associated with the second different database operator.

14. The system of claim 1 wherein at least one of the core system and second portal is further configured to provide a file to the particular database operator, wherein the file comprises the first data feed.

15. The system of claim 1 wherein at least one of the core system and the second portal is further configured to transmit the first data feed to the particular database operator in response to a request from the particular database operator for the transmission of the first data feed.

16. The system of claim 1 wherein the core system is further configured to transmit the first data feed in real-time to the particular database operator.

17. The system of claim 1 further configured to transmit a message to the particular database operator, wherein the message comprises at least a subset of the first data feed.

18. The system of claim 1 wherein at least one of the core system and the second portal is further configured to:
generate an information request in response to an input by the particular database operator, wherein the information request comprises an email message; and
configure the information request to include a link to the first portal.

19. The system of claim 18 wherein at least one of the core system and the second portal is further configured to transmit the information request to an individual selected by the particular database operator.

20. The system of claim 1 wherein the second portal is further configured to:
receive a selection of user information from the particular database operator, wherein the selection of user information comprises particular categories of user information that is requested by the particular database operator; and
provide the selection of user information to the first portal to be presented to the particular user.

21. The system of claim 1 wherein the core system is further configured to generate a widget for the particular database operator, wherein the widget links the website associated with the particular database operator to the first portal.

22. The system of claim 1 wherein the first portal is configured to be accessed by a website associated with the particular database operator, wherein the website uses a widget to provide access to the first portal.

23. A machine-implemented method to distribute user information, the method comprising:
receiving user information, a data selection signal and a database operator signal through a first portal, wherein the user information comprises at least one of contact data or biographical data associated with a particular user, wherein the data selection signal comprises a first signal designating at least a subset of the user information associated with the particular user, and wherein the database operator signal comprises a signal identifying a particular database operator to receive the subset of the user information;
providing access to a first data feed, wherein the first data feed comprises the subset of the user information associated with the particular user and is accessible only by the particular database operator; and
providing a second different database operator with access to a second data feed, wherein the second data feed is accessible only by the second different database operator.

24. The machine-implemented method of claim 23 wherein the first data feed further comprises a real-time data feed.

25. The machine-implemented method of claim 23 further comprising updating a database maintained by the particular database operator using information in the first data feed.

26. The machine-implemented method of claim 23 further comprising providing the subset of user information to the particular database operator without receiving a request from the particular database operator to provide user information of the particular user.

27. The machine-implemented method of claim 23 further comprising outputting privacy information associated with the particular database operator.

28. The machine-implemented method of claim 23 further comprising:
receiving a request from the particular database operator, wherein the request comprises a request for a particular subset of the particular user's user information;
receiving a second data selection signal, wherein the second data selection signal comprises a second signal designating at least a subset of the particular subset of the particular user's user information; and
updating the first data feed with the subset of the particular subset of the particular user's user information.

29. The machine-implemented method of claim 23 further comprising:
receiving a membership list through the second portal, wherein the membership list comprises information relating to the members of the population of the second different database operator;
analyzing the user information and the membership list to determine whether at least a portion of the user information is included in the membership list; and
outputting information associated with the second different database operator through the first portal if the user information is included in the membership list.

30. The machine-implemented method of claim 23 further comprising:
receiving verification information from the particular user;
receiving a business code from the particular database operator; and
analyzing the verification information and the business code to confirm the identity of the particular user.

31. The machine-implemented method of claim 23 further comprising:
generating an information request in response to an input by the particular database operator;
configuring the information request to include a link to the first portal.

32. The machine-implemented method of claim 23 further comprising:
analyzing the user information to predict whether the particular user would desire a relationship with the second different database operator; and
providing information associated with the second different database operator to the first portal based on the prediction.

33. The machine-implemented method of claim 32 wherein the prediction of whether the particular user would desire a relationship with the second different database operator is based on analyzing the user information and a geographic area of operation associated with the second different database operator.

34. The machine-implemented method of claim 23 further comprising providing a file to the particular database operator, wherein the file comprises the first data feed.

35. The machine-implemented method of claim 23 further comprising transmitting the first data feed to the particular database operator in response to a request from the particular database operator for the transmission of the first data feed.

36. The machine-implemented method of claim 23 further comprising transmitting a message to the particular database operator, wherein the message comprises at least a subset of the first data feed.

37. The machine-implemented method of claim 23 further comprising transmitting the first data feed in real-time to the particular database operator.

38. A user interface comprising:
a user input section configured to receive user information, wherein the user information comprises at least one of contact data or biographical data associated with a particular user;
a display section configured to display a list of one or more database operators and, for each of the one or more database operators, display at least one category of requested user information, the display section further configured to receive a user selection, wherein the user selection comprises a selection of at least one category of user information requested by one of the database operators; and
a submission section configured to allow the particular user to submit the user information and the user selection to a server and/or a database.

39. The user interface of claim 38 wherein the display section is configured to display a list of a plurality of database operators and, for each of the one or more database operators, display at least on category of requested user information.

40. The user interface of claim 38 further comprising a search input configured to receive database operator information and, in response, to cause a search for a particular database operator to be performed based on the database operator information.

41. The user interface of claim 38 wherein the display section is further configured to display information associated with one or more suggested database operators.

42. The user interface of claim 38 wherein the display section is further configured to:
display information associated with one or more database operators and
allow a user to browse the information associated with the one or more database operators.

43. The user interface of claim 38 wherein the user interface comprises a graphical user interface.

44. A user interface comprising:
a first interface section configured to confirm the identity of a database operator for the purpose of providing access to a unique data feed;
a second interface section configured to provide the database operator with access to the unique data feed, wherein the unique data feed comprises user information associated with at least one particular individual associated with the database operator and is accessible only by the database operator; and
an input configured to receive a membership list, wherein the membership list comprises information associated with one or more individuals associated with a database operator.

45. The user interface of claim 44 wherein the user interface comprises a graphical user interface.

46. The user interface of claim 44 further comprising a third interface section configured to allow the particular database operator to review the data feed.
